(19) United States
(12) Patent Application Publication
(10) Pub. No.: US 2023/0073884 A1
(43) Pub. Date: Mar. 9, 2023

(54) METHOD AND SYSTEM TO PERFORM A SECURE BOOT PROCEDURE USING A MULTI-STAGE SECURITY VERIFICATION IN A MICROCONTROLLER OF A VEHICLE

(71) Applicant: GM GLOBAL TECHNOLOGY OPERATIONS LLC, Detroit, MI (US)

(72) Inventors: Brian Farrell, Troy, MI (US); Thomas M. Forest, Macomb, MI (US)

(73) Assignee: GM GLOBAL TECHNOLOGY OPERATIONS LLC, Detroit, MI (US)

(21) Appl. No.: 17/470,295

(22) Filed: Sep. 9, 2021

(51) Int. Cl. G06F 21/57; G06F 21/54; G06F 21/60; G06F 21/79

(52) U.S. Cl. CPC G06F 21/575; G06F 21/54; G06F 21/602; G06F 21/79; G06F 2221/0751

(57) ABSTRACT

A method to perform secure boot procedure using a multi-stage security verification is provided. The procedure includes, within a microcontroller, referring to a table to identify a first defined memory region including code useful to start-up application programming of the microcontroller, wherein the application programming is operable to provide a function of the microcontroller to the vehicle, and a second defined memory region, including programming and data useful to operation of the application programming of the microcontroller. The procedure further includes, within a first stage, verifying authenticity of contents of the first region and starting-up the application programming of the microcontroller based upon verifying the authenticity of the contents of the first region. The procedure further includes, within a second stage, verifying authenticity of contents of the second region and operating the application programming to provide the function based upon verifying the authenticity of the contents of the second region.

### INTRODUCTION

The disclosure generally relates to a method and system to perform a secure boot procedure using a multi-stage security verification in a microcontroller of a vehicle.

A microcontroller is a device including a computerized processor useful to operate programming. Computerized processors operate programming or programmed instructions stored in digital memory. In some instances, an application, software application, or data may be stored in code flash memory or data flash memory. Security protocols are operated to check the authenticity of the application and/or data stored in the memory.

### SUMMARY

A method to perform a secure boot procedure using a multi-stage security verification in a microcontroller of a vehicle is provided. The method includes operating the secure boot procedure within the microcontroller. The secure boot procedure includes referring to a secure boot information table to identify a first defined memory region including initialization code useful to start-up application programming of the microcontroller and a second defined memory region, including programming and data useful to operation of the application programming of the microcontroller. The application programming is operable to provide a function of the microcontroller to the vehicle. The procedure further includes, within a first stage of the multi-stage security verification, verifying authenticity of contents of the first defined memory region and starting-up the application programming of the microcontroller based upon verifying the authenticity of the contents of the first defined memory region. The procedure further includes, within a second stage of the multi-stage security verification, verifying authenticity of contents of the second defined memory region and operating the application programming to provide the function of the microcontroller to the vehicle based upon verifying the authenticity of the contents of the second defined memory region.

In some embodiments, the method further includes selectively providing secret key information to the microcontroller based upon verifying the authenticity of the contents of the second defined memory region.

In some embodiments, the second defined memory region further includes calibration data useful to the application programming.

In some embodiments, the method further includes referring to the secure boot information table to identify a third defined memory region that is unused and, within a third stage of the multi-stage security verification, verifying authenticity of contents of the third defined memory region.

In some embodiments, verifying authenticity of the contents of the second defined memory region includes activating a portion of the application programming to produce an output message, comparing the output message to a stored verification data table value, and verifying the authenticity of the contents of the second defined memory region based upon the comparing.

In some embodiments, verifying authenticity of the contents of the second defined memory region includes activating a portion of the application programming to produce a plurality of output messages including a calculated message digest, comparing each of the plurality of output messages to corresponding stored verification data, and verifying the authenticity of the contents of the second defined memory region based upon the comparing.

In some embodiments, the method further includes activating a portion of the application programming to produce an output message and monitoring a time period used to produce the output message. Verifying the authenticity of contents of the second defined memory region includes confirming that the time period used to produce the output message is less than a threshold time period.

In some embodiments, the first defined memory region and the second defined memory region are within a code flash memory device of the microcontroller.

In some embodiments, the secure boot information table is stored within the code flash memory device.

In some embodiments, the method further includes receiving updated application programming including an application signed header including a verification message digest and storing the updated application programming within the microcontroller. In some embodiments, the method further includes activating a portion of the updated application programming to produce a plurality of output messages including a calculated message digest, comparing the calculated message digest to the verification message digest, and storing a portion of the plurality of output messages as values in a verification data table within the microcontroller.

In some embodiments, storing the updated application programming within the microcontroller includes referencing the application signed header within the updated programming, comparing the application signed header to signature verification data stored within the microcontroller, and storing the updated application programming within the microcontroller based upon the application signed header matching the signature verification data.

In some embodiments, referring to the secure boot information table to identify the second defined memory region includes identifying a start address of the second defined memory region and a region length.

According to one alternative embodiment, a method to perform a secure boot procedure using a multi-stage security verification in a microcontroller of a vehicle is provided. The method includes operating the secure boot procedure within the microcontroller. The secure boot procedure includes referring to a secure boot information table to identify a first defined memory region including initialization code useful to start-up application programming of the microcontroller and a second defined memory region, including programming and data useful to operation of the application programming of the microcontroller. The application programming is operable to provide a function of the microcontroller to the vehicle. The procedure further includes, within a first stage of the multi-stage security verification, verifying authenticity of contents of the first defined memory region and starting-up the application programming of the microcontroller based upon verifying the authenticity of the contents of the first defined memory region. The procedure further includes, within a second stage of the multi-stage security verification, attempting to verify authenticity of contents of the second defined memory region. When the authenticity of the contents of the second defined memory region is verified, the method further includes operating the application programming to provide the function of the microcontroller to the vehicle based upon verifying the authenticity of the contents of the second defined memory region. When the authenticity of the contents of the second defined memory region is not verified, the method further includes resetting the microcontroller.

In some embodiments, the method further includes, when the authenticity of the contents of the second defined memory region is not verified, quarantining the microcontroller.

In some embodiments, the method further includes, when the authenticity of the contents of the second defined memory region is not verified, notifying an operator of the vehicle.

In some embodiments, the method further includes, when the authenticity of the contents of the second defined memory region is not verified, activating a redundant microcontroller in the vehicle.

According to one alternative embodiment, a system to perform a secure boot procedure using a multi-stage security verification in a microcontroller of a vehicle is provided. The system includes the microcontroller, which includes an application processor operable to execute application programming of the microcontroller. The application programming is operable to provide a function of the microcontroller to the vehicle. The microcontroller further includes a code flash memory device storing the application programming, a hardware security module processor operating the secure boot procedure. The secure boot procedure includes referring to a secure boot information table to identify a first defined memory region within the code flash memory device, including initialization code to start-up the application programming of the microcontroller and a second defined memory region within the code flash memory device, including programming and data useful to operation of the application programming of the microcontroller. The secure boot procedure further includes, within a first stage of the multi-stage security verification, verifying authenticity of contents of the first defined memory region and starting-up the application programming of the microcontroller based upon verifying the authenticity of the contents of the first defined memory region. The secure boot procedure further includes, within a second stage of the multi-stage security verification, verifying authenticity of contents of the second defined memory region and operating the application programming to provide the function of the microcontroller to the vehicle based upon verifying the authenticity of the contents of the second defined memory region.

In some embodiments, the secure boot information table is stored upon the code flash memory device.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates a computerized microcontroller, including an application portion and a hardware security module portion, in accordance with the present disclosure;

FIG. 2 schematically illustrates the memory device of the application portion of FIG. 1, including a code flash memory device and a data flash memory device, in accordance with the present disclosure;

FIG. 3 schematically illustrates one of the memory portions of FIG. 2, with the memory portion divided into memory modules, in accordance with the present disclosure;

FIG. 4 schematically illustrates an exemplary embodiment of a code flash memory device including host boot manager software and an application useful for operating a portion of a vehicle and additionally illustrates a plurality of messages being generated by the application being used to check the authenticity of the application, in accordance with the present disclosure;

FIG. 5 schematically illustrates a sequence of start-up operations stored within a secure boot configuration, in accordance with the present disclosure;

FIG. 6 schematically illustrates a first of the sequence steps of FIG. 5 broken down into sub-operations, in accordance with the present disclosure;

FIG. 7 schematically illustrates a second of the sequence steps of FIG. 5 broken down into sub-operations, in accordance with the present disclosure;

FIG. 8 schematically illustrates a third of the sequence steps of FIG. 5 broken down into sub-operations, in accordance with the present disclosure;

FIG. 9 schematically illustrates a fourth of the sequence steps of FIG. 5 broken down into sub-operations, in accordance with the present disclosure;

FIG. 10 is a flowchart illustrating a method to perform an exemplary verification operation, in accordance with the present disclosure;

FIG. 11 is a flowchart illustrating a method to classify a start-up sequence as one of confirming authenticity or challenging authenticity of a stored application and/or data, in accordance with the present disclosure;

FIG. 12 schematically illustrates a system configuration useful to update and verify authenticity of the update for a computerized application, in accordance with the present disclosure;

FIG. 13 is a flowchart illustrating actions useful to update and verify authenticity of the update for a computerized application, in accordance with the present disclosure; and

FIG. 14 schematically illustrates a vehicle including a plurality of computerized microcontrollers, each utilizing the disclosed methods and system, in accordance with the present disclosure.

### DETAILED DESCRIPTION

Computerized processors operate programming or programmed instructions stored in digital memory. Security threats exist, and adversarial parties may write programming that may be used for nefarious purposes. A security peripheral may be utilized to identify such programming that has been loaded onto microcontrollers within a vehicle. In one embodiment, a security peripheral may include a hardware security module including a security processing device operating in parallel to an application processing device, with the hardware security module checking the authenticity of the application processing device and components available thereto.

The purpose for the application processing device to exist in a vehicle is to execute a software application within the vehicle. In one instance, an application processing device may be a motor controller useful to control one or more electric motors in a vehicle. In another instance, an application processing device may be a battery controller, controlling charging and discharging cycles of one or more battery packs in the vehicle. In another instance, the application processing device may be a navigational controller, either providing navigational information to an operator of the vehicle or controlling navigation of the vehicle autonomously.

Various forms of memory devices are available to store digital information. Flash memory or solid-state memory devices are useful for providing access to data quickly, in time periods measured in milli-seconds. In some instances, an application, software application, or data may be stored in code flash memory or data flash memory. Code flash memory and data flash memory may include similar or same physical structure and may be defined based upon how the memory is utilized. In one embodiment, code flash memory may be utilized to store an application code and/or constant data, and data flash memory may be utilized to store application or emulation data.

Security protocols are operated to check the authenticity of the application and/or data stored in the memory. A security protocol may check contents within a memory region and make sure the contents include expected code or data. A security protocol may check messages being generated by an application and make sure the messages match an expected message or expected output. A security protocol may check regions of memory that are supposed to be empty and make sure that those regions are in fact empty. A security protocol may track time to verify a particular region and make sure that the time to verify the region does not go over a threshold time period. A security protocol may protect some types of information, for example, secret keys or secret data keys that may be used to initiate reactions in various vehicle systems. In one embodiment, a security peripheral may hold the secret keys, for example, for an automated braking operation in the vehicle, until the programming within an automated braking controller is verified.

In a computerized microcontroller in a general setting, a start-up protocol including a security peripheral taking relatively large periods of time, for example, a few seconds, may be acceptable. In such general settings, a sequence of operations may be followed. However, in vehicular systems, a computerized controller may be prompted to start up and respond in a relatively short time measured in milliseconds. In one embodiment, a computerized controller in a vehicle may be useful to start-up and provide a response within 50 to 60 milliseconds.

A method to perform a secure boot procedure using a multi-stage security verification in a microcontroller of a vehicle is provided. The secure boot procedure may be operated within the microcontroller of the vehicle. The method and system provide a secure boot information table (SBIT) enabling a prioritized multi-stage security verification of the contents of a memory device of a microcontroller. The SBIT may contain information useful to the security peripheral to rapidly identify which regions of memory are to be verified at particular stages of a secure boot operation. The multi-stage verification enables a relatively large amount of code flash contents to be verified while maintaining boot timing priorities for the microcontroller. A first stage may be operated where code flash contents including programming useful to start an application of the microcontroller is verified with priority over other data.

In one embodiment, the multi-stage security verification enables the security peripheral to operate a first stage where at least one memory region of a plurality of memory regions in the memory device including programming and data useful to enable start-up of the application software of the microcontroller is verified. The multi-stage security verification may further enable the security peripheral to operate a second stage where a remainder of memory regions of the plurality of memory regions are verified.

In another embodiment, the multi-stage security verification may further enable the security peripheral to operate a second stage where at least one memory region of the plurality of memory regions including programming and data useful to enable operation and generation of outputs by the application software is verified. The multi-stage security verification may further operate a third stage where at least one of the plurality of memory regions that is supposed to be empty is verified.

In another embodiment, the multi-stage security verification may further enable the security peripheral to operate a second stage where at least one memory region of the plurality of memory regions including programming and data useful to enable operation of the application software requiring use of secret keys is verified. The multi-stage verification may permit the use of secret keys when the second stage verifies the at least one memory region. The multi-stage security verification may further operate a third stage where at least one memory region of the plurality of memory regions that is supposed to be empty is verified.

If the security peripheral fails to verify the contents of the code flash memory device at a point, the security peripheral may reset the microcontroller to deny intruding software a time window to execute. The security peripheral may execute a command to wipe the contents of the unverified code flash contents and command an update of the code flash memory device. The security peripheral may command that the unverified code flash memory device or the microcontroller including the unverified code flash memory device be sequestered or quarantined to prevent unintended operation of the vehicle and prevent the unverified code from being transmitted or copied to other microcontrollers within the vehicle. The security peripheral may notify a user or operator of the vehicle of an error state. The security peripheral may enable use of back-up or redundant microcontrollers or systems within the vehicle to compensate for the unverified code and the quarantined microcontroller. The security peripheral may command vehicle shut-down if no redundant microcontroller or system is available to continue operation of the vehicle.

A host boot manager may be stored upon a code flash memory device. The host boot manager may operate programming to start-up the application of the microcontroller upon an application processing device of the microcontroller. A security peripheral such as a hardware security module operating a security processing device may operate in parallel to the application processing device.

Within the microcontroller, a code flash memory device may be used to store programming related to an application operated by the microcontroller. The security peripheral may utilize information stored upon a verified SBIT to verify contents of the code flash memory device used to store the application. The SBIT providing information useful for the security peripheral to operate a multi-stage security verification of a memory device may be stored upon either a code flash memory device or a data flash memory device. In one embodiment, storing the SBIT upon the code flash memory device may provide relatively faster processing, as a delay is inherent to accessing data from a data flash memory device as compared to accessing data from the code flash memory device storing the application.

In one embodiment, the SBIT providing information useful for the security peripheral to operate a multi-stage security verification of the code flash memory device may be stored within a same memory region of the code flash memory device as the application. In one embodiment, the SBIT may be stored as part of the programming of the application.

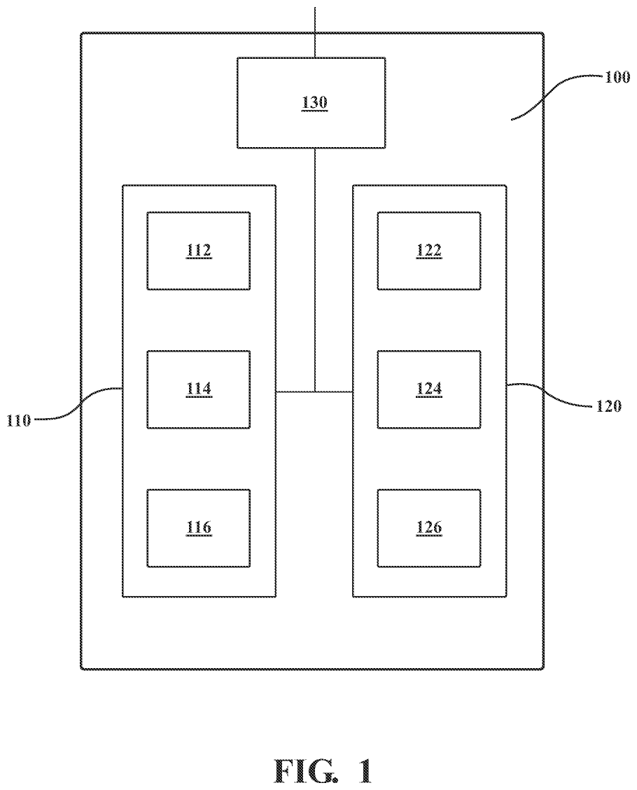

Referring now to the drawings, wherein like reference numbers refer to like features throughout the several views, FIG. 1 schematically illustrates a computerized microcontroller 100, including an application portion 110 and a hardware security module portion 120. The microcontroller 100 further includes a communication device 130 operable to permit the microcontroller 100 to communicate with electronic devices throughout the vehicle. The application portion 110 includes an application processor device 112, random access memory 114 useful for the application processor device 112, and a memory device 116 useful for the application processor device 112. The hardware security module portion 120 includes a security processor device 122, random access memory 124 useful for the security processor device 122, and a memory device 126 useful for the security processor device 122. The application portion 110 is operable to start-up an application through a boot operation and operate the application to provide functionality of the microcontroller 100. For example, where the microcontroller 100 is a braking system controller for a vehicle, the application portion 110 may operate an application to monitor inputs such as a brake pedal position and provide an output such as commands to a plurality of braking actuators.

The hardware security module portion 120 is operable to act as a security peripheral according to the method and system disclosed herein. The hardware security module portion 120 may access information from an SBIT stored within the memory device 116 and operate a prioritized multi-stage security verification of the contents of the memory device 116.

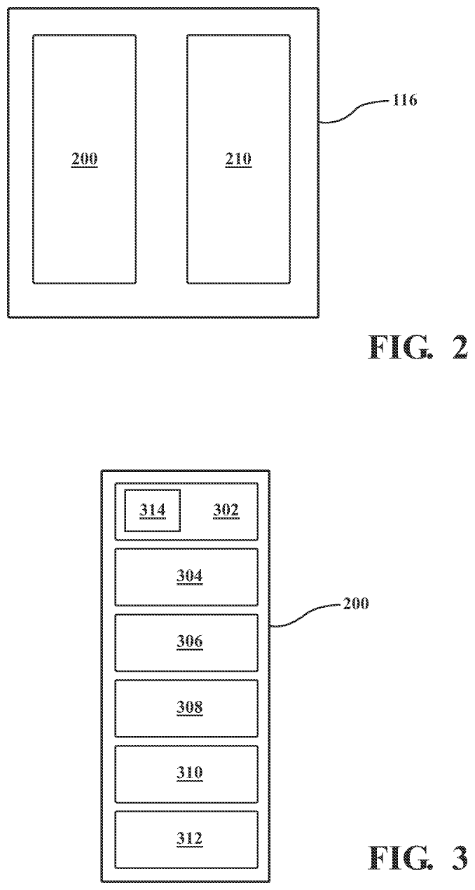

FIG. 2 schematically illustrates the memory device 116, including a code flash memory device 200 and a data flash memory device 210. The memory device 126 of FIG. 1 may be identical to the memory device 116. The code flash memory device 200 includes programming related to the application of the microcontroller 100 of FIG. 1 and programming related to a host boot manager useful to start-up the application. The data flash memory device 210 includes additional data.

FIG. 3 schematically illustrates an exemplary embodiment of the code flash memory device 200 of FIG. 2. The code flash memory device 200 is illustrated including memory module 302, memory module 304, memory module 306, memory module 308, memory module 310, and memory module 312. In another embodiment, the code flash memory device may include additional memory modules, for example, including a host boot manager program. The memory module 302 is illustrated storing programming related to an application program. The memory module 302 is further illustrated including a stored SBIT 314. The memory module 304 is illustrated including programming and/or data useful to the operation of the application program but not useful for the initiation of the application program. The memory module 304 may include software that does not execute as part of the initialization of the application software. In one exemplary embodiment, initializing an application may involve initialization code stored in memory module 302 that utilizes some period, e.g. 30 milliseconds, to execute. The memory module 306 is illustrated as an empty or unused memory region. The memory module 308 and the memory module 310 are illustrated including calibration data useful to the operation of the application program but not useful for the initiation of the application program. The memory module 312 is illustrated as an empty or unused memory region.

Memory module 302, memory module 304, memory module 306, memory module 308, memory module 310, and memory module 312 may be physically distinct structures or chips upon a circuit board or they may be specified memory regions of a unified memory device. Memory regions may be defined within the memory modules, for example, by defining a memory region start address and a memory region length. Such a defined memory region may be treated in isolation of other memory regions within a memory device or a memory module. For example, if an application program is known to be within a particular defined memory region, that defined memory region may be analyzed within a first stage of the disclosed method and system, so as to verify the contents of that defined memory region before the application programming is initiated or given access to secret keys.

The SBIT 314 may include instructions to operate a multi-stage security verification, wherein a first stage is defined to include verification of memory module 302 including the application program and programming and data useful to initiate or boot the application program. A second stage is defined to include the memory module 304, the memory module 308, and the memory module 310, including programming and data useful to operate the application program. A third stage is defined to include the memory module 306 and the memory module 312, including two memory regions that are supposed to be empty and without programming or data.

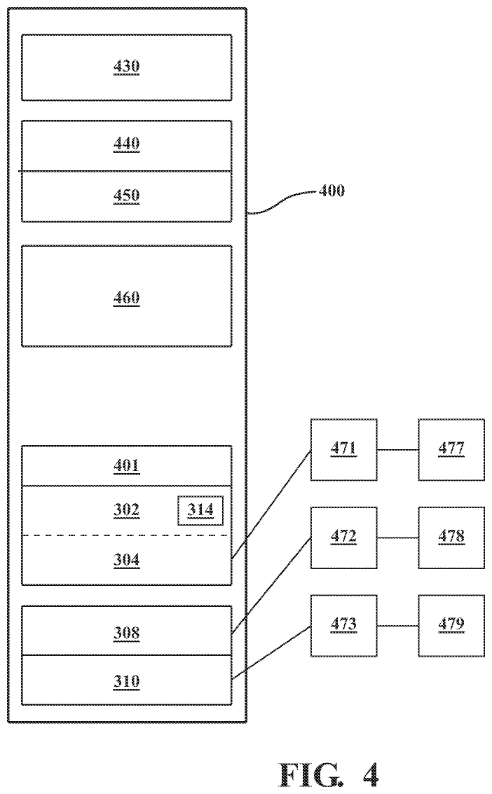

FIG. 4 schematically illustrates a second exemplary embodiment of a code flash memory device 400 including host boot manager software and an application useful for operating a portion of a vehicle and additionally illustrates a plurality of messages being generated by the application being used to check the authenticity of the application. The code flash memory device 400 includes a memory region 430 storing a host boot manager, a memory region 440 storing root public key (RPK) information, electronic control unit identifier (ECU ID), message authentication code (MAC), a memory region 450 storing host bootloader MACs, and a memory region 460 storing a host bootloader. The host boot manager includes code that the application processor executes at start-up. It may be stored in one-time programmable memory (OTP), which obviates verifying the host boot manager code. RPK information is data used to verify software and calibration updates. The ECU ID is a unique identifier for each electronic control unit (ECU). The MAC is message authentication code that is created by the hardware security module using a secret key. The MAC is stored with the data so that the hardware security module portion 120 of FIG. 1 can verify its authenticity. An alternative to using a MAC is to store the RPK Info and the ECU ID with the boot manager in the OTP so that it can't be changed. The code flash memory device 400 further includes a memory region 401 storing application software information (which may include an application signed header), a memory module 302 storing programming related to an application program and an SBIT 314, a memory module 304 including programming and/or data useful to the operation of the application program but not useful for the initiation of the application program, and memory module 308 and memory module 310 storing calibration data useful to the operation of the application program. The contents of the memory module 302, the memory module 304, the memory module 308, and the memory module 310 may be verified in an exemplary two stage security verification, with the contents of the memory module 302 being analyzed in a first stage, thereby enabling rapid start-up of the application programming stored therein, and with the contents of the memory module 304, the memory module 308, and the memory module 310, including programming and data useful to the operation of the application program, being analyzed in a second stage.

One method to verify the contents of the memory modules or memory regions containing the application program and programming and data useful to the operation of the application program may include analyzing the outputs or messages generated by the application programming and associated programming to verify that the application programming is operating as anticipated. Message 471 is generated as an output of the application software within the memory module 304 by the hardware security module portion 120 of FIG. 1 using a secret key stored within the hardware security module portion 120, message 472 is generated as an output of programming and calibration data within the memory module 308 by the hardware security module portion 120 of FIG. 1 using a secret key stored within the hardware security module portion 120, and message 473 is generated as an output of programming and calibration data within the memory module 310 and the memory module 304 by the hardware security module portion 120 of FIG. 1 using a secret key stored within the hardware security module portion 120. The output message 471, the output message 472, and the output message 473 are message authentication codes, which are relatively small pieces of data created over other pieces of data (usually relatively larger) using a secret key that allows the authenticity of that data to be verified. The output message 471 is compared to a stored expected output message 477 in the hardware security module portion 120 of FIG. 1, and the output message 471 and corresponding operation of the application programming may be verified based upon the comparison. The output message 472 is compared to a stored expected output message 478 in the hardware security module portion 120 of FIG. 1, and the output message 472 and corresponding operation of the application programming and associated programming may be verified based upon the comparison. The output message 473 is compared to a stored expected output message 479 in the hardware security module portion 120 of FIG. 1, and the output message 473 and corresponding operation of the programming associated with the application programming may be verified based upon the comparison. Based upon whether the contents of the memory regions or memory modules is verified by examining whether the output messages generated by the application programming and associated programming are verified, the security peripheral operated by the hardware security module portion 120 of FIG. 1 may verify or challenge whether the application portion 110 of FIG. 1 has been compromised by unauthorized programming.

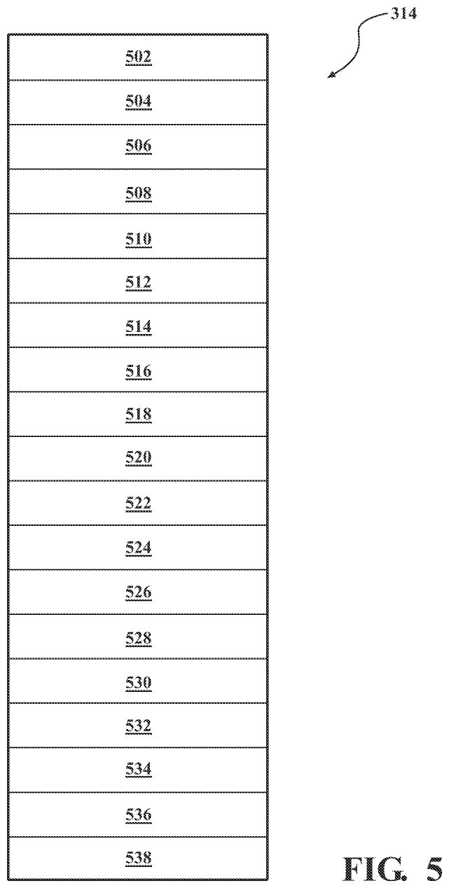

FIG. 5 schematically illustrates an exemplary sequence of start-up operations stored within an SBIT 314. The SBIT 314 is illustrated including sequence step 502 which defines a stage 1 information offset, defining which sequence step of the SBIT 314 a process may skip to for information related to one or more defined memory regions to be analyzed in a first stage of a multi-stage security verification. The sequence step 502 may instruct a process to skip to sequence step 526 which provides a location of defined memory region or regions to be verified in stage 1. A sequence step 504 is illustrated which defines a stage 2 information offset, defining which sequence step of the SBIT 314 a process may skip to for information related to one or more defined memory regions to be analyzed in a second stage of a multi-stage security verification. The sequence step 504 may instruct a process to skip to sequence step 528 which provides a location of defined memory region or regions to be verified in stage 2. A sequence step 506 is illustrated which defines a stage 3 information offset, defining which sequence step of the SBIT 314 a process may skip to for information related to one or more defined memory regions to be analyzed in a third stage of a multi-stage security verification. The sequence step 506 may instruct a process to skip to sequence step 530 which provides location of a defined memory region or regions to be verified in stage 3.

A sequence step 508 is illustrated providing a number of memory module groupings present in the code flash memory device being analyzed in second and third stages of the multi-stage security verification, which in the illustrated example includes four memory module groupings. A sequence step 510 defines and provides a reference name for a first memory module grouping including a memory module including programming and data useful to operation of an application program (for example, the memory module 304 of FIG. 3). A sequence step 512 provides an offset or location for the first memory module grouping. A sequence step 514 defines and provides a reference name for a second memory module grouping including a first memory module including calibration data useful to operation of an application program (for example, the memory module 308 of FIG. 3). A sequence step 516 provides an offset or location for the second memory module grouping. A sequence step 518 defines and provides a reference name for a third memory module grouping including a second memory module including calibration data useful to operation of an application program (for example, the memory module 310 of FIG. 3). A sequence step 520 provides an offset or location for the third memory module grouping. A sequence step 522 defines and provides a reference name for a fourth memory module grouping including a memory module including unused or empty modules (for example, the memory module 306 and the memory module 312 of FIG. 3). A sequence step 524 provides an offset or location for the fourth memory module grouping. The definitions of the various memory modules and their contents may change with updates to the programming and updates to the SBIT 314, for example, as programming and data parameters are added, deleted, or modified.

The sequence step 526 provides a location of a memory module or a defined memory region or regions to be verified in stage 1. The sequence step 526 may provide reference to the memory module or memory region storing the application programming. The sequence step 528 provides a location of a defined memory region or regions to be verified in stage 2. The memory modules or memory regions to be analyzed may be identified by memory module (entire modules to be analyzed in the stage) or by one or more defined memory regions (including a start address and a length of memory to be analyzed.) In the embodiment of FIG. 5, the defined memory regions to be verified in stage 2 include the first memory module grouping, the second memory module grouping, and the third memory module grouping defined in the sequence step 510, the sequence step 514, and the sequence step 518, respectively. The sequence step 528 may provide reference to sequence step 532, sequence step 534, and sequence step 536 which may provide information related to start addresses and lengths of the first memory module grouping, the second memory module grouping, and the third memory module grouping, respectively, to be analyzed in stage 2. The sequence step 530 provides a location of a defined memory region or regions to be verified in stage 3. In the embodiment of FIG. 5, the defined memory regions to be verified in stage 3 include the fourth memory module grouping defined in the sequence step 522. The sequence step 530 may provide reference to sequence step 538, which may provide information related to start addresses and lengths of two different memory modules or memory regions to be analyzed in stage 3. The sequence steps and data therein illustrated in relation to SBIT 314 are exemplary. A number of additional or alternative sequence steps are envisioned to convey the same or similar details, and the disclosure is not intended to be limited to the examples provided herein.

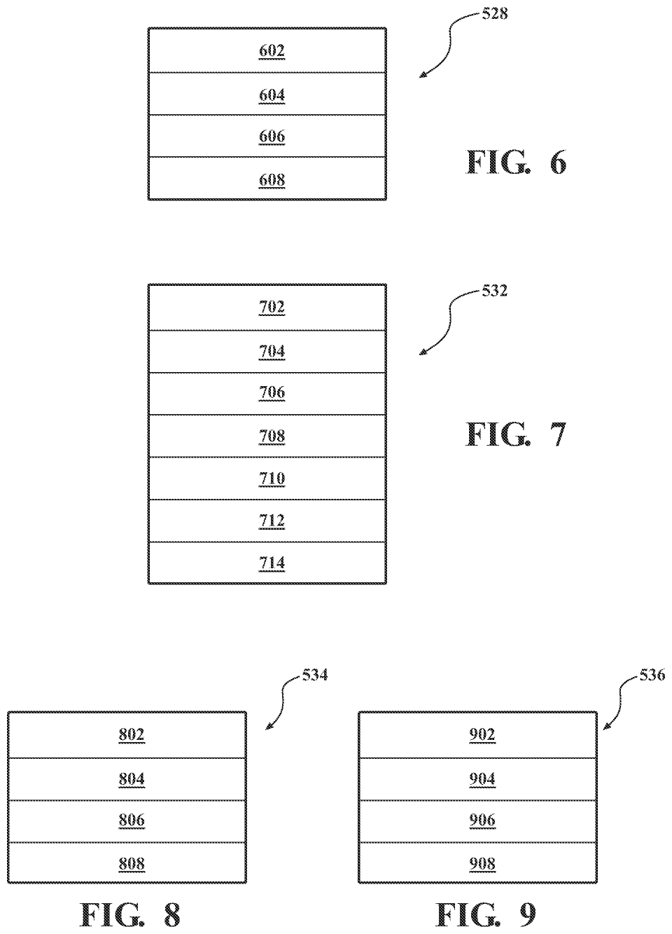

The sequence step 528 provides a location of a defined memory region or regions to be verified in stage 2 of an exemplary multi-step security verification. FIG. 6 schematically illustrates the sequence step 528 of FIG. 5 broken down into sub-operations. The sequence step 528 is illustrated, including sub-operation 602 which defines a number of defined memory regions (or in this case, memory module groupings) to be analyzed in stage 2, which in the exemplary illustration equals three defined memory regions. A sub-operation 604 is provided which provides a location of data or provides an offset to data defining a first defined memory region (the first memory module grouping.) In the embodiment of FIG. 5, the first defined memory region is provided within sequence step 532. The sub-operation 604 may provide an offset to access or proceed to sequence step 532. A sub-operation 606 is provided which provides a location of data or provides an offset to data defining a second defined memory region (the second memory module grouping.) In the embodiment of FIG. 5, the second defined memory region is provided within sequence step 534. The sub-operation 606 may provide an offset to access or proceed to sequence step 534. A sub-operation 608 is provided which provides a location of data or provides an offset to data defining a third defined memory region (the third memory module grouping.) In the embodiment of FIG. 5, the third defined memory region is provided within sequence step 536. The sub-operation 608 may provide an offset to access or proceed to sequence step 536.

FIG. 7 schematically illustrates the sequence step 532 of FIG. 5 broken down into sub-operations. The sequence step 532 is illustrated, including sub-operation 702 which defines a number of sub-regions that combine to create the first defined memory region (i.e., the first memory module grouping defined in sequence step 510 of FIG. 5) referenced in the sub-operation 604 of FIG. 6. In the embodiment of FIG. 7, two sub-regions are defined. In sub-operation 704, a sub-region 1 start address is provided. In sub-operation 706, a sub-region 1 length is defined. By providing the start address and the length of the sub-region, the contents of the sub-region or the portion of the memory associated with the sub-region to be analyzed may be defined. At sub-operation 708, a verification data table or location within the memory device 126 of FIG. 1 in which verification data to confirm the contents of sub-region 1 is provided. In sub-operation 710, a sub-region 2 start address is provided. In sub-operation 712, a sub-region 2 length is defined. By providing the start address and the length of the sub-region, the contents of the sub-region or the portion of the memory associated with the sub-region to be analyzed may be defined. At sub-operation 714, a verification data table or location within the memory device 126 of FIG. 1 in which verification data to confirm the contents of sub-region 2 is provided. The sub-region 1 and the sub-region 2 combine to form the first defined memory region or, in this case, the first memory module grouping.

FIG. 8 schematically illustrates the sequence step 534 of FIG. 5 broken down into sub-operations. The sequence step 534 is illustrated, including sub-operation 802 which defines a number of sub-regions that combine to create the second defined memory region (i.e., the second memory module grouping defined in sequence step 514 of FIG. 5) referenced in the sub-operation 606 of FIG. 6. In the embodiment of FIG. 8, one sub-region is defined. In sub-operation 804, the sub-region start address is provided. In sub-operation 806, a sub-region length is defined. By providing the start address and the length of the sub-region, the contents of the sub-region or the portion of the memory associated with the sub-region to be analyzed may be defined. At sub-operation 808, a verification data table or location within the memory device 126 of FIG. 1 in which verification data to confirm the contents of the sub-region is provided.

FIG. 9 schematically illustrates the sequence step 536 of FIG. 5 broken down into sub-operations. The sequence step 536 is illustrated, including sub-operation 902 which defines a number of sub-regions that combine to create the third defined memory region (i.e., the third memory module grouping defined in sequence step 518 of FIG. 5) referenced in the sub-operation 608 of FIG. 6. In the embodiment of FIG. 9, one sub-region is defined. In sub-operation 904, the sub-region start address is provided. In sub-operation 906, a sub-region length is defined. By providing the start address and the length of the sub-region, the contents of the sub-region or the portion of the memory associated with the sub-region to be analyzed may be defined. At sub-operation 908, a verification data table or location within the memory device 126 of FIG. 1 in which verification data to confirm the contents of the sub-region is provided.

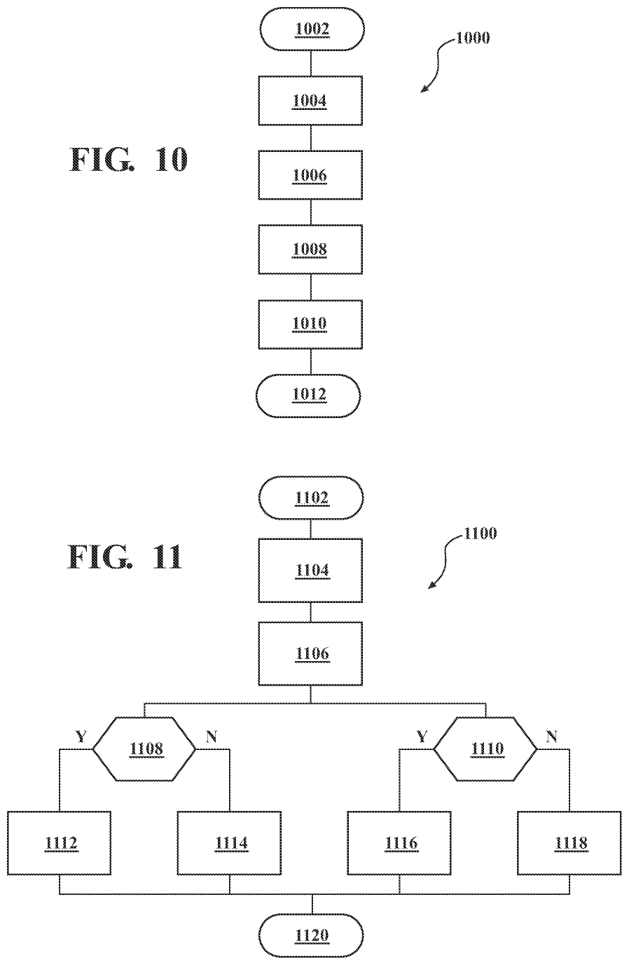

FIG. 10 is a flowchart illustrating a method 1000 to perform stage 2 of the exemplary multi-stage security verification operation described in FIG. 5. Method 1000 starts at step 1002. At step 1004, stage 2 offset data from the SBIT 314 is accessed and used to locate the defined memory regions to be analyzed in stage 2. At step 1006, output messages generated by the sub-region 1 and by the sub-region 2, defined in sequence step 532 of FIG. 7, are generated and compared to respective verification data table values. At step 1008, an output message generated by the sub-region defined in sequence step 534 of FIG. 8 is generated and compared to a respective verification data table value. At step 1010, an output message generated by the sub-region defined in sequence step 536 of FIG. 9 is generated and compared to a respective verification data table value. The method 1000 ends at step 1012. The method 1000 may be part of a larger method and may provide verification information for use in verifying or challenging authenticity of the operation and software contents of a microcontroller. The method 1100 is exemplary, and this disclosure is not intended to be limited to the examples provided herein.

FIG. 11 is a flowchart illustrating a method 1100 to classify a start-up sequence as one of verifying authenticity or challenging authenticity of the operation and software contents of a microcontroller. The method 1100 starts at step 1102. At step 1104, an SBIT is first verified and then referenced, and defined memory regions are identified for verification. At step 1106, a start-up process is initiated, and verification of the defined memory regions is performed in multiple stages. Results of the verification processes are analyzed in parallel within step 1108 and step 1110. In step 1108, the result of verification, for example, examining the contents of defined memory regions by comparing output messages to verification data table values is performed. If the verification methods affirmatively confirm that the memory contents of the microcontroller are verified as having authenticity, the process advances to step 1112 where the software and the associated microcontroller may be approved for full use by the vehicle. If the verification methods fail to verify the memory contents as having authenticity, the process advances to step 1114, where the microcontroller may be reset and other actions including quarantine described herein may be performed. At step 1110, the verification process is examined, and if a time used to verify the authenticity of one of the defined memory regions takes longer than a threshold time period, a lack of authenticity may be assumed. If the verification process does complete before the threshold time period, the method 1100 advances to step 1116, where results of the verification process may be given weight and used to verify that the memory contents of the microcontroller have authenticity and have not been compromised. If the verification process does not complete before the threshold time period, the method 1100 advances to step 1118, where the microcontroller may be reset and other actions including quarantine described herein may be performed. The method 1100 ends at step 1120. The method 1100 is exemplary, and this disclosure is not intended to be limited to the examples provided herein.

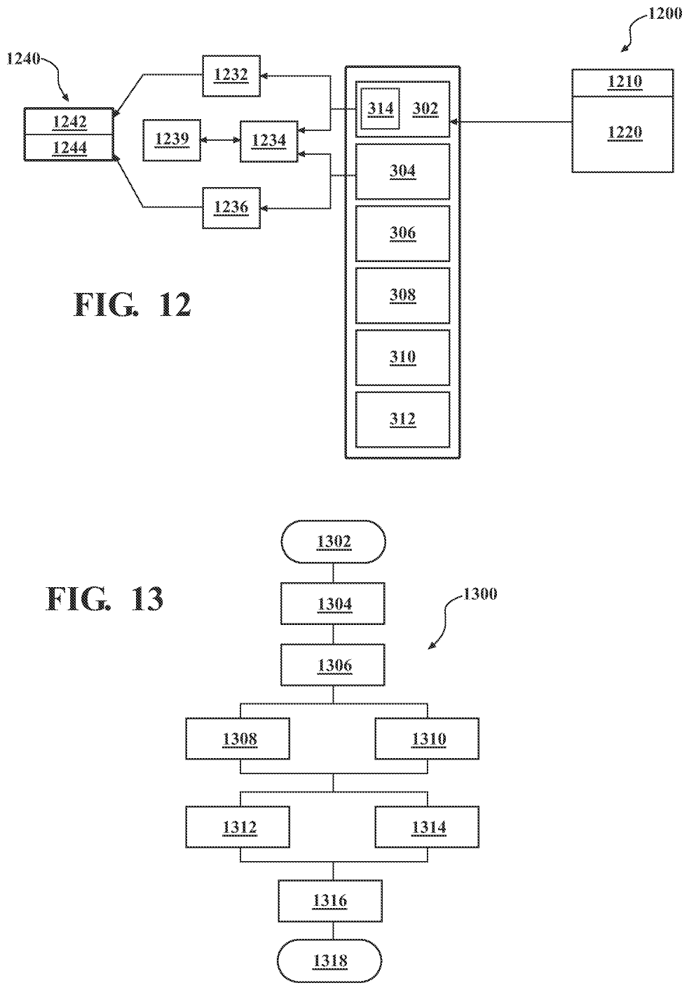

FIG. 12 schematically illustrates a system configuration useful to update and verify authenticity of the update for a computerized application. A code flash memory device is illustrated including the memory module 302, the memory module 304, the memory module 306, the memory module 308, the memory module 310, and the memory module 312. The memory module 302 is further illustrated including a stored SBIT 314. The code flash memory device operates similarly to the code flash memory device 200 of FIG. 3. An updating device 1200 is provided, which stores and may transfer updated software including an application signed header 1210 and updated application programming 1220. The application signed header 1210 may include information about the updated application programming 1220 to confirm that the correct application is being updated for the specific code flash memory device. The application signed header 1210 may additionally include signature data useful to permit an update if the signature data is correctly verified with signature verification data stored by the code flash memory device.

The updated software may be verified according to the method and system disclosed herein. Message 1232 is generated as an output of the application software within the memory module 302 by the hardware security module portion 120 of FIG. 1 using a secret key stored within the hardware security module portion 120, message 1236 is generated as an output of programming within the memory module 304 by the hardware security module portion 120 of FIG. 1 using a secret key stored within the hardware security module portion 120, and message 1234 is generated as an output of programming within the memory module 302 and the memory module 304. The message 1232 and the message 1236 are message authentication codes, which are relatively small pieces of data created over other pieces of data (usually relatively larger) using a secret key that allows the authenticity of that data to be verified.

The message 1234 may include a calculated message digest. A verification message digest 1239 may be provided within the application signed header 1210 and used to compare to the message 1234. Based upon whether the contents of the memory regions or memory modules is verified by examining whether the output messages generated by the application programming and associated programming are verified, the security peripheral operating as described herein may verify or challenge whether the microcontroller operating the code flash memory device of FIG. 12 has been compromised by unauthorized programming. If the comparison of the message 1234 to the verification message digest 1239 confirms the contents of the code flash memory device of FIG. 12, a verification data table 1240 may be generated or updated with verification value 1242 including the value of output message 1232 and verification value 1244 including the value of output message 1236. In this way, by utilizing the verification message digest 1239 to validate the message 1234, the verification data table 1240 may be populated with verified data and used for later iterations of multi-stage security verifications, such as is described in relation to FIG. 4.

FIG. 13 is a flowchart illustrating a method 1300 useful to update and verify authenticity of the update for a computerized application. The method 1300 starts a step 1302. At step 1304, an update for a microcontroller including an application signed header including a verification message digest and an updated application is received, and the signature of the application signed header is compared to stored signature data to confirm the authenticity of the update. Once the update is confirmed as authentic, the update is used to write new stored programming and data upon a code flash memory device. At step 1306, information from an SBIT provided within the update is accessed and used to identify defined memory regions within the code flash memory operable to produce output messages. At step 1308, a first defined memory region (e.g., the module storing the application software) is activated to produce an associated output message. At step 1310, message digest information is calculated and stored. At step 1312, a second defined memory region is activated to produce an associated output message. At step 1314, message digest information continues to be calculated and stored. At step 1316, the calculated message digest information is compared to verification message digest information. If the calculated message digest information matches the verification message digest information, then the output messages produced at step 1308 and step 1312 are used to create verification data values in a stored verification data table within a hardware security module portion of the microcontroller. At step 1318, the method 1300 ends. The method 1300 is exemplary, and this disclosure is not intended to be limited to the examples provided herein.

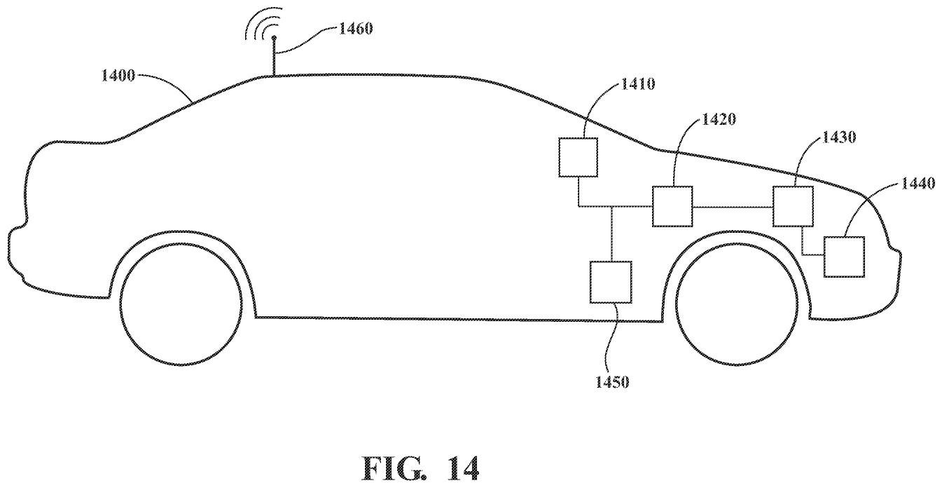

FIG. 14 schematically illustrates a vehicle 1400 including a plurality of computerized microcontrollers, each utilizing the disclosed methods and system. The vehicle 1400 is illustrated, including an exemplary navigational controller 1410, an exemplary battery system controller 1420, and an exemplary motor controller 1430. The navigational controller 1410 includes an application with programming to navigate the vehicle, for example, to determine a navigational path upon a roadway according to methods in the art. The battery system controller 1420 includes an application with programming to manage energy storage within a battery system 1450, including charging cycles and discharging cycles, according to methods in the art. The motor controller 1430 includes an application with programming to control a propulsion motor 1440 generating an output torque effective to propel the vehicle according to methods in the art. The navigational controller 1410, the battery system controller 1420, and the motor controller 1430 may each include an application processor operating the respective application for each controller and may additionally each include a hardware security module processor operating the disclosed method and system including multi-stage security verification for the respective controller. The vehicle 1400 may further include a wireless communication system 1460 operable to receive updated software in order to update the application programming for the controllers, as described herein.

Vehicle security is an important consideration in vehicles, in particular vehicles including autonomous and semi-autonomous functions. Preventing an unscrupulous actor from exerting unauthorized control over the functioning of the vehicle is useful. The features of the disclosed method and system improve vehicle security and make vehicle operators more secure. In one embodiment, a method to perform secure boot procedure using a multi-stage security verification is provided. The procedure includes, within a microcontroller, referring to a table to identify a first defined memory region including code useful to start-up application programming of the microcontroller, wherein the application programming is operable to provide a function of the microcontroller to the vehicle, and a second defined memory region, including programming and data useful to operation of the application programming of the microcontroller. The procedure further includes, within a first stage, verifying authenticity of contents of the first region and starting-up the application programming of the microcontroller based upon verifying the authenticity of the contents of the first region. The procedure further includes, within a second stage, verifying authenticity of contents of the second region and operating the application programming to provide the function based upon verifying the authenticity of the contents of the second region. In being performed thusly, the disclosed method permits the programming used to initialize the application software to be checked, the application software to begin initialization, and then for a remainder of the programming for the application software to be checked as the initialization progresses. In this way, vehicle security and speed of initialization may be balanced and preserved, thereby solving a pressing technical problem for vehicle operators.

While the best modes for carrying out the disclosure have been described in detail, those familiar with the art to which this disclosure relates will recognize various alternative designs and embodiments for practicing the disclosure within the scope of the appended claims.

What is claimed is:

1. A method to perform a secure boot procedure using a multi-stage security verification in a microcontroller of a vehicle, comprising:
operating the secure boot procedure within the microcontroller, including:
referring to a secure boot information table to identify:
a first defined memory region including initialization code useful to start-up application programming of the microcontroller, wherein the application programming is operable to provide a function of the microcontroller to the vehicle; and
a second defined memory region, including programming and data useful to operation of the application programming of the microcontroller;
within a first stage of the multi-stage security verification, verifying authenticity of contents of the first defined memory region;
starting-up the application programming of the microcontroller based upon verifying the authenticity of the contents of the first defined memory region;
within a second stage of the multi-stage security verification, verifying authenticity of contents of the second defined memory region; and
operating the application programming to provide the function of the microcontroller to the vehicle based upon verifying the authenticity of the contents of the second defined memory region.

2. The method of claim 1, further comprising:
selectively providing secret key information to the microcontroller based upon verifying the authenticity of the contents of the second defined memory region.

3. The method of claim 1, wherein the second defined memory region further includes calibration data useful to the application programming.

4. The method of claim 1, further comprising:
referring to the secure boot information table to identify a third defined memory region that is unused; and
within a third stage of the multi-stage security verification, verifying authenticity of contents of the third defined memory region.

5. The method of claim 1, wherein verifying authenticity of the contents of the second defined memory region includes:
activating a portion of the application programming to produce an output message;
comparing the output message to a stored verification data table value; and
verifying the authenticity of the contents of the second defined memory region based upon the comparing.

6. The method of claim 1, wherein verifying authenticity of the contents of the second defined memory region includes:
activating a portion of the application programming to produce a plurality of output messages including a calculated message digest;
comparing each of the plurality of output messages to corresponding stored verification data; and
verifying the authenticity of the contents of the second defined memory region based upon the comparing.

7. The method of claim 1, further comprising:
activating a portion of the application programming to produce an output message; and
monitoring a time period used to produce the output message; and
wherein verifying the authenticity of contents of the second defined memory region includes confirming that the time period used to produce the output message is less than a threshold time period.

8. The method of claim 1, wherein the first defined memory region and the second defined memory region are within a code flash memory device of the microcontroller.

9. The method of claim 8, wherein the secure boot information table is stored within the code flash memory device.

10. The method of claim 1, further comprising:
receiving updated application programming including an application signed header including a verification message digest;
storing the updated application programming within the microcontroller;
activating a portion of the updated application programming to produce a plurality of output messages including a calculated message digest;
comparing the calculated message digest to the verification message digest; and
storing a portion of the plurality of output messages as values in a verification data table within the microcontroller.

11. The method of claim 10, wherein storing the updated application programming within the microcontroller includes:
referencing the application signed header within the updated programming;
comparing the application signed header to signature verification data stored within the microcontroller; and
storing the updated application programming within the microcontroller based upon the application signed header matching the signature verification data.

12. The method of claim 1, wherein referring to the secure boot information table to identify the second defined memory region includes identifying a start address of the second defined memory region and a region length.

13. A method to perform a secure boot procedure using a multi-stage security verification in a microcontroller of a vehicle, comprising:
operating the secure boot procedure within the microcontroller, including:
referring to a secure boot information table to identify:
a first defined memory region including initialization code useful to start-up application programming of the microcontroller, wherein the application programming is operable to provide a function of the microcontroller to the vehicle; and
a second defined memory region, including programming and data useful to operation of the application programming of the microcontroller;
within a first stage of the multi-stage security verification, verifying authenticity of contents of the first defined memory region;
starting-up the application programming of the microcontroller based upon verifying the authenticity of the contents of the first defined memory region;
within a second stage of the multi-stage security verification, attempting to verify authenticity of contents of the second defined memory region;
when the authenticity of the contents of the second defined memory region is verified, operating the application programming to provide the function of the microcontroller to the vehicle based upon verifying the authenticity of the contents of the second defined memory region; and
when the authenticity of the contents of the second defined memory region is not verified, resetting the microcontroller.

14. The method of claim 13, further comprising, when the authenticity of the contents of the second defined memory region is not verified, quarantining the microcontroller.

15. The method of claim 13, further comprising, when the authenticity of the contents of the second defined memory region is not verified, notifying an operator of the vehicle.

16. The method of claim 13, further comprising, when the authenticity of the contents of the second defined memory region is not verified, activating a redundant microcontroller in the vehicle.

17. A system to perform a secure boot procedure using a multi-stage security verification in a microcontroller of a vehicle, comprising:
the microcontroller, including:
an application processor operable to execute application programming of the microcontroller, wherein the application programming is operable to provide a function of the microcontroller to the vehicle;
a code flash memory device storing the application programming;
a hardware security module processor operating the secure boot procedure, including:
referring to a secure boot information table to identify:
a first defined memory region within the code flash memory device, including initialization code to start-up the application programming of the microcontroller; and
a second defined memory region within the code flash memory device, including programming and data useful to operation of the application programming of the microcontroller;
within a first stage of the multi-stage security verification, verifying authenticity of contents of the first defined memory region;
starting-up the application programming of the microcontroller based upon verifying the authenticity of the contents of the first defined memory region;
within a second stage of the multi-stage security verification, verifying authenticity of contents of the second defined memory region; and
operating the application programming to provide the function of the microcontroller to the vehicle based upon verifying the authenticity of the contents of the second defined memory region.

18. The system of claim 17, wherein the secure boot information table is stored upon the code flash memory device.
